(19) United States
(12) Patent Application Publication
(10) Pub. No.: US 2021/0207990 A1
(43) Pub. Date: Jul. 8, 2021

(54) CONTAINER COMPRISING A VALVE HEAD FOR PNEUMATIC DOSING AND DOSING FACILITY COMPRISING SUCH A CONTAINER

(71) Applicant: BASF COATINGS GMBH, Müenster (DE)

(72) Inventor: Alexander KUESENER, Muenster (DE)

(21) Appl. No.: 17/059,462

(22) PCT Filed: May 28, 2019
(86) PCT No.: PCT/EP2019/063798

§ 371 Date: Nov. 29, 2020

(30) Foreign Application Priority Data
May 29, 2018 (EP) 18174819.5

(51) Int. Cl. G01G 11/08; G01G 11/00; B01F 7/00

(52) U.S. Cl. CPC G01G 11/08; G01G 11/003; B01F 2215/005; B01F 7/00633; B01F 7/0025

(57) ABSTRACT

Described herein is a container suitable for pneumatic metering of a component situated therein into another container, wherein the container includes a container body, a container base, and a removable cover suitable for closing the container. The container has at least one valve head, at least one compressed air connection for the pneumatic driving of the valve head and at least one further compressed air connection that are integrated into the cover of the container, and a stirrer that is also integrated into the cover. Also described herein are the use of the container, a metering system including at least one container, a method for pneumatic metering using the container, and a method for producing a coating composition or a precursor thereof that can be used in the automotive industry, which method makes use of the container.

The present invention relates to a container (1) which is suitable for the pneumatic metering of a component situated therein into another container different from the container (1), wherein the container (1) comprises a container body (2), a container base (2a) and a removable cover (3) suitable for closing the container (1), wherein the container (1) has at least one valve head (9), which is recessed into the container base (2a) and to which it is possible to connect a container (10) which is different from the container (1) and into which pneumatic metering of a component situated in the container (1) can be performed, at least one compressed air connection (4) for the pneumatic driving of the valve head (9) and at least one further compressed air connection (5) are integrated into the cover (3) of the container (1), and a stirrer (7) is integrated into the cover (3), the use of the container (1) according to the invention for the abovementioned purpose, a metering system (20) comprising at least one container (1) according to the invention, a method for pneumatic metering using the container (1), and a method for producing a coating composition or a precursor thereof that can be used in the automotive industry, which method makes use of the container (1).

### PRIOR ART

Coating compositions that can be used in the automotive industry are nowadays produced both on a (large) industrial scale and for development purposes in the laboratory, generally using metering systems suitable for this purpose. Industrial systems of this kind used in this sector are generally based on a gravimetric procedure, which makes use of pivotable and fixed valves. The metering valves of such systems are connected by pipes to a storage system. The storage system comprises delivery packages or fixed tanks for supplying material to the metering system and is connected to the metering system by firmly anchored pipe systems. Owing to the use of fixed pipes in combination with firmly anchored metering valves within these conventional metering systems, said systems cannot be used or deployed in a flexible and mobile way.

Particularly in the case of metering systems which are used to produce coating compositions within laboratories, such as research and development laboratories, this is disadvantageous, however, since compositions developed in such laboratories, such as primer surfacers, base coats, top coats, including clear coats, and precursors used to produce these coats, such as pigment pastes or intermediates, generally differ, in some cases very widely, in terms of their composition. Thus, for example, a large number of very different additives, which differ very widely from one another both chemically and in respect of their intended use, are used to produce such compositions. It is impractical to connect all these additives to metering valves by fixed pipes and respective storage packages or tanks located in a central store since, overall, the variation and thus total number of possible additives is far too high and, furthermore, the metered quantities and frequency of metering of the individual additives is far too small relative to the total number of coating compositions produced. To ensure connection of all additives that could possibly be used to the metering system, a number of fixed pipes and storage tanks that was no longer economically viable would have to be made available for this purpose. Moreover, permanently making available such a high number of different additives would involve the risk of having to dispose of a large quantity of these additives unused after a certain time owing to the abovementioned relatively infrequent metering thereof since at least some of the additives used are not sufficiently stable (for storage), at least over a long period of time.

In principle, corresponding disadvantages also apply to the storage of pigment pastes in such assemblies of fixed pipes, storage tanks and metering valves since, in practice, only a very small number of such pastes overall generally appear to be worth holding in tanks or storing, for the reasons stated in connection with the abovementioned additives (especially in respect of the quantity and frequency of metering thereof). Owing to the relatively low frequency of metering of such pastes overall, the majority of them would thus merely block the existing supply lines. In the case of continuously changing paste compositions (paste shades) within the existing storage tanks, on the other hand, the effort involved in cleaning the fixed piping would be far too high from an economic point of view since, of course, not only the tank itself but also the fixed pipes would have to be subjected to cleaning in the event of a change from one paste to another within one tank.

Moreover, special-effect pigment pastes, in particular, do not have adequate shear stability when used in assemblies of fixed pipes, storage tanks and metering valves, i.e. for these reasons alone, such pastes cannot be supplied from storage packages functioning as supply packages via fixed pipes to the respective valves of the metering system. Irrespective thereof, there is furthermore the problem, especially when using aluminum pigments as special-effect pigments, that when there is a need to change the raw material these pigments cannot be removed completely from the pipes, even with intensive pipe cleaning. As a result, once piping has been used for this purpose, it can only be used exclusively for the respective specific aluminum pigment type. It would only be possible to transfer a different special-effect pigment or a different raw material to the valve via this fixed pipe with extremely high expenditure (on cleaning)—if at all. In practice, fixed pipes must therefore generally be removed and replaced instead in such cases since the aluminum pigments can no longer be removed without residues, even with intensive cleaning.

The prior art furthermore includes metering systems which comprise flexible metering units and supply packages, e.g. those of Full Systembau GmbH. The valves of these metering units are controlled by means of a mechanical drive. However, such mechanical drives are often very fault-prone and must therefore be serviced relatively frequently. Moreover, mechanical valve control is relatively complex, is often too inaccurate during metering and does not allow only short activation times, especially activation times in the range of milliseconds. Furthermore, the progressive control, entailed by the use of mechanical drives, of the metering valves via the degree of valve opening in combination with the weighing signal means that the latter must always be continuously present or supplied, and, as a result, a discontinuous mode of operation is impossible. With these known metering systems, the respective metering unit must furthermore be conveyed in each case to the package into which the respectively desired components are to be metered and not vice versa, i.e. the metering units are not positioned at a fixed point within the metering section but must be moved. However, the disadvantage of this type of pivoted valve that is required is that these valves are arranged in a ring and the maximum number of valves is limited owing to this circular arrangement. In the case of such pivotable metering valves, the prior art comprises rings with a maximum of 80 different valves. In the case of valves that can be arranged in series, a limit in respect of the number thereof is imposed by the dimensions of the building within which they are situated.

There is therefore a requirement for metering systems which not only can be used for a large number of different coating systems but are also designed in such a way that they offer sufficient flexibility, mobility and accuracy and do not have the abovementioned disadvantages, especially those which are associated with unwanted expenditure on cleaning of individual component parts of the metering system.

### Object

It is therefore an object of the present invention to provide a metering station and a metering system containing a metering station of this kind which have advantages over the metering stations and metering systems known from the prior art. In particular, it is an object of the present invention to provide a metering station and a metering system containing a metering station of this kind which can be used in a flexible and mobile way and allow economically advantageous operation of metering systems with as far as possible full, or at least considerable, minimization of cleaning steps, especially where the intention is to meter special-effect pigment pastes.

### Solution

This object is achieved by the subject matter claimed in the patent claims and by the preferred embodiments of this subject matter which are described in the following description.

A first subject of the present invention is therefore a container (1) which is suitable for the pneumatic metering of a component situated therein into another container (10) different from the container (1), wherein the container (1) comprises a container body (2), a container base (2a) and a removable cover (3) suitable for closing the container (1), wherein
the container (1) has at least one valve head (9), which is recessed into the container base (2a) and to which it is possible to connect a container (10) which is different from the container (1) and into which pneumatic metering of a component situated in the container (1) can be performed,
at least one compressed air connection (4) for the pneumatic driving of the valve head (9) and at least one further compressed air connection (5) are integrated into the cover (3) of the container (1), wherein delivery of a component situated in the container (1) for the purpose of metering into the container (10) can be performed by means of compressed air applied to the connection (5), and
a stirrer (7), which comprises a motor (8) for driving the stirrer (7) on the outside (3a) of the cover (3) and which, on the inside (3b) of the cover (3), has a stirrer shaft (7a), which can be driven by means of the motor (8) and which comprises one or more stirring members (7b) mounted on the stirrer shaft (7a), is integrated into the cover (3), wherein the stirrer shaft (7a) is arranged in such a way on the inside (3b) of the cover (3) that it projects into the container body (2) in the state of the container (1) in which said container is closed by means of the cover (3).

A further subject of the present invention is the use of the container (1) according to the invention as a, preferably mobile, metering station for the pneumatic metering of a component situated therein into another container (10) different from the container (1).

A further subject of the present invention is a metering system (20) comprising at least one container (1) according to the invention as a, preferably mobile, metering station, wherein, in addition to the at least one container (1) according to the invention used as at least one, preferably mobile, metering station, the metering system (20) according to the invention can furthermore optionally contain at least one supply container (30), which is connected by means of at least one pipe (31) to at least one metering valve (32), which is a permanent component part of the metering system (20).

A further subject of the present invention is a method for pneumatic metering using the container (1) according to the invention, wherein the method comprises at least one step (i), namely
(i) pneumatic metering of a component situated in the container (1) according to the invention into another container different from the container (1).

A further subject of the present invention is a method for producing a coating composition or a precursor thereof that can be used in the automotive industry, wherein the method comprises at least one step (a), namely
(a) pneumatic metering of a component situated in the container (1) according to the invention into another container different from the container (1), wherein, after being produced, the coating composition or the precursor thereof is present in this container (10) different from the container (1).

It has surprisingly been found that the container (1) according to the invention used as a metering station, in particular as part of the metering system (20) according to the invention, makes it possible to completely eliminate a change of raw materials within supply containers and fixed pipes, which is necessary in the case of conventional metering systems when producing very different coating compositions, since the container (1) can be incorporated into and removed again from the metering system (20) according to the invention in a simple manner at any time. If a change of raw materials is due, e.g. from component A to component B, the container (1) containing component A can simply be removed from the metering system (20), and a container (1) containing component B can be incorporated. Exchange within a single supply container is thus not necessary. Since the container (1) according to the invention itself forms an independent metering station and contains a metering valve head (9), the cleaning both of the supply container and of the pipes and valves which would otherwise be necessary in the case of a change of raw materials is furthermore eliminated. This advantage is inherent particularly when a change of raw materials is relatively expensive, i.e. where the fitting time is long and the required cleaning takes a long time, as in the case of special-effect pigment pastes, for example, which are often not stable when pumped and residues of which otherwise often remain in the existing pipes and valves. However, such special-effect pigment pastes can be metered without problems by means of the container (1) according to the invention used as a metering station, in particular as part of the metering system (20) according to the invention, since, in this case, neither pumps nor pipes are used. The container (1) according to the invention used as a metering station, in particular as part of the metering system according to the invention, thus surprisingly allows very high flexibility in the production of coating compositions or precursors thereof, especially within laboratories such as research and development laboratories, especially when metering components which, although in frequent use, are used only in small quantities, such as additives, or in the case of components with insufficient storage stability and/or pumping stability, such as special-effect pigment pastes.

Moreover, pneumatic metering makes it possible to achieve activation times in the range of milliseconds. Thus, metering control of the metering valves via the parameter of the opening duration of the valves can achieve significantly more accurate metering results, even in combination with simultaneous stirring, than is possible by means of mechanically driven metering valves. Furthermore, pneumatic metering also makes it possible to operate discontinuously, i.e. activation for the duration of valve opening and subsequently, only after this metering, weighing and automatic adaptation of the follow-up metering for the duration of valve opening.

### DETAILED DESCRIPTION

Container (1) According to the Invention

The container (1) according to the invention is suitable for the pneumatic metering of a component situated therein into another container (10) different from the container (1). The container (1) according to the invention is therefore used as a metering station and forms such a metering station, in particular as part of a metering system. The container (1) according to the invention preferably forms a mobile metering station and can therefore also be referred to as an interchangeable valve container.

The container body (2) of the container (1) according to the invention preferably contains at least one component which can be used to produce a coating composition or a precursor thereof that can be used in the automotive industry, and which is to be subjected to pneumatic metering by means of the container (1) according to the invention. Solutions or dispersions are preferably used as corresponding components.

The container (1) according to the invention preferably does not contain a pump, in particular a pump used to deliver any components to be fed into the container (1) or transfer them out of said container. The container (1) according to the invention preferably does not contain any pipe(s), in particular any that can be used to carry components situated therein or for introducing components into the container (1).

Fundamentally, any type of material is suitable for producing the container (1), in particular the container body (2). However, the container (1), in particular the container body (2), is preferably manufactured from at least one metal or at least one alloy. To produce the container (1) and, in particular, the container body (2), steel is preferably used, particularly preferably stainless steel.

The volume of the container body (2) is preferably in a range of from 1 to 20 l, particularly preferably in a range of from 1.5 to 10 l, very particularly preferably in a range of from 2 to 8 l, especially in a range of from 2.5 to 6 l.

The container body (2) of the container (1) according to the invention is preferably substantially round. In this case, the dead volume within the container body (2) is only very small or entirely absent, thus enabling mixing by means of the stirrer (7) to take place in an optimum way in the container body.

At least one compressed air connection (4) for the pneumatic driving of the valve head (9) is integrated into the cover (3) of the container (1) according to the invention. A compressed air line can be connected to the compressed air connection (4). The compressed air connection (4) is used for pneumatically driving and for controlling the valve head (9). The compressed air connection (4) is preferably part of a valve drive unit (4a), which is situated on the outside of the cover (3a) and by means of which pneumatic metering is made possible. A valve drive rod (6), by means of which the valve head (9) is connected to the compressed air connection (4), is preferably furthermore part of this valve drive unit (4a).

At least one further compressed air connection (5) is integrated into the cover (3) of the container (1) according to the invention. A compressed air line can be connected to the compressed air connection (5). The compressed air connection (5) is used to deliver a component situated in the container (1) for the purpose of metering into the container (10). Via this connection (5) an excess pressure, preferably of up to 0.5 bar, particularly preferably in a range of from 0.05 to 0.4 bar, in particular from 0.1 to 0.4 bar, is applied, preferably by means of compressed air, in order to ensure continuous delivery of the at least one component which is situated in the container (1) and is to be metered into the container (10). By applying compressed air to the connection (5), it is thus possible to produce an excess pressure within the container (1) when the latter is closed by means of the cover (3). A continuous volume flow of the component contained in the container (1) is thereby produced and makes possible metering by means of the metering valve head (9).

The container (1) according to the invention has at least one valve head (9), which is recessed into the container base (2a) and to which it is possible to connect a container (10) which is different from the container (1) and into which pneumatic metering of a component situated in the container (1) can be performed. The metering valve head (9) is preferably suitable for metering both fine flows and coarse flows. The valve head (9) preferably therefore has at least two different valve openings. This is preferably achieved by virtue of the fact that the valve head (9) has a ring (9a) made of Teflon for metering coarse flows and furthermore a pin (9b) made of metal situated in the center of this Teflon ring for metering fine flows. Both the ring (9a) and the pin (9b) are preferably preloaded with a spring closing action and are operated or controlled pneumatically by means of compressed air via the compressed air connection (4). In this way, for example, both valve openings, i.e. the ring (9a) and the pin (9b), are opened when a relatively high excess pressure, of 5 bar for example, is applied (coarse flow). When a relatively low excess pressure of, for example, just 2 bar is applied, on the other hand, only the pin (9b) is opened, i.e. only fine metering then takes place. In this case, the ring (9a) remains closed since the applied excess pressure of 2 bar is not sufficient to compensate or overcome the spring force of the ring (9a).

The metering valve head (9) is preferably connected by means of a valve drive rod (6) to the compressed air connection (4), in particular as part of the valve drive unit (4a), which is situated on the outside of the cover (3a) and by means of which the pneumatic metering is made possible. In particular, the metering valve head (9) is connected to the valve drive unit (4a) by means of a valve drive rod (6).

The valve drive unit (4a) furthermore preferably comprises an adjusting screw (4b), by means of which the metering valve head (9) can be opened and closed and by means of which the valve opening(s), e.g. the ring (9a) and/or the pin (9b), can be adjusted. In this case, the adjusting screw (4b) preferably presses against the spring-loaded valve head (9) or against the spring-loaded ring (9a) and the spring-loaded pin (9b).

It is possible to connect to the valve head (9) of the container (1) according to the invention a container (10) different from the container (1), into which pneumatic metering of a component situated in the container (1) is supposed to take place. Quick-acting closures and/or clips, which are preferably screwable, are suitable for connection for this purpose, for example. As a particular preference, a tri-clamp union is used.

The valve head (9) is preferably situated on the container base (2a) in a position above which the stirrer shaft (7a) projects into the body (2).

In the state of the container (1) in which it is closed by means of the cover (3), the container (1) according to the invention is preferably usable at an excess pressure of up to 0.5 bar, particularly preferably of up to 0.4 bar, especially of up to 0.3 bar, which can be produced by means of the compressed air connection (5).

An excess pressure of up to 8 bar can preferably be applied to the compressed air connection (4) which can be used for the pneumatic driving of the metering valve head. An excess pressure of 0.5 to 6 bar can preferably be produced here, wherein higher values, e.g. 3.5 to 6 or up to 5 bar are used for coarse metering and lower values, e.g. 0.5 or 1 bar to 1.5 or 2 bar, are employed for fine metering.

A stirrer (7), which comprises a motor (8) for driving the stirrer (7) on the outside (3a) of the cover (3) and which, on the inside (3b) of the cover (3), has a stirrer shaft (7a), which can be driven by means of the motor (8) and which comprises one or more stirring members (7b) mounted on the stirrer shaft (7a), is integrated into the cover (3) of the container (1), wherein the stirrer shaft (7a) is arranged in such a way on the inside (3b) of the cover (3) that it projects, preferably centrally, into the container body (2) in the state of the container (1) in which said container is closed by means of the cover (3). In this arrangement, however, the container base (2a) is touched neither by the stirrer shaft (7a) nor by the at least one stirring member (7b).

The cover (3) can be removed from the container (1) according to the invention and is used to close the container (1). The container (1) is preferably reclosable by means of the cover (3) at any time. Quick-acting closures and/or clips, which are preferably screwable, are suitable for closure, for example. As a particular preference, a tri-clamp union is used.

The stirrer (7) of the container (1) preferably comprises a stirrer shaft (7a), which is capable of a maximum speed in the range of 100 to 500 rpm, particularly preferably of 200 to 400 rpm. The height of the stirrer shaft (7a) is preferably adjustable. This allows optimum mixing of the contents of the container (1), whatever the quantity introduced.

Any type of stirring member (7b) can be used. The stirring members (7b) are preferably selected from the group comprising propellers, pitched blades, disks, swashplates, hollow blades, impellers, crossbeams, anchors, paddles, gates and toothed disks. Propellers are particularly preferred.

The valve drive rod (6) of the container (1) according to the invention preferably projects further into the container body (2) than the stirrer shaft (7a) in the state of the container (1) in which it is closed by means of the cover (3).

The motor (8) is preferably flanged onto the outside (3a) of the cover (3) of the container (1). An electrically operated motor (8) is preferably used. As a particular preference, a radial piston motor or a vane motor is used as the motor (8). A radial piston motor is a very particular preference.

Use According to the Invention

A further subject of the present invention is the use of the container (1) according to the invention as a, preferably mobile, metering station for the pneumatic metering of a component situated therein into another container (10) different from the container (1).

All the preferred embodiments described hereinabove in connection with the container (1) according to the invention are also preferred embodiments in respect of the use according to the invention of the container (1) according to the invention.

In this context, the container (1) according to the invention is preferably used as a mobile metering station.

The use according to the invention preferably serves for the production of special-effect pigment pastes.

Metering System According to the Invention

The container (1) according to the invention can preferably act as part of a metering system. A further subject of the present invention is therefore a metering system (20) comprising at least one container (1) according to the invention as a, preferably mobile, metering station.

All the preferred embodiments described hereinabove in connection with the container (1) according to the invention and the use according to the invention are also preferred embodiments in respect of the use of the container (1) according to the invention as part of the metering system (20) according to the invention.

The container (1) according to the invention can thus be integrated into a metering system (20), preferably by means of hooking into a position envisaged for this purpose within the metering system (20). The metering system (20) according to the invention preferably comprises up to 50 available metering points, at which a respective container (1) according to the invention can be positioned as a metering station.

The metering system (20) according to the invention preferably comprises up to 50 of the containers (1) according to the invention and hence up to 50 metering stations. In addition, the metering system (20) according to the invention can comprise a supply station (24), into which further containers (1) according to the invention can be integrated if required. These further containers (1) according to the invention then form a supply of such containers (1) within the metering system and permit an even wider range of containers (1).

The at least one container (1) according to the invention integrated into the metering system (20) according to the invention is thus preferably part of the metering section specified by the design of the metering system (20). An (empty) container, which is a different container from the container (1) according to the invention, into which pneumatic metering of a component situated in the container (1) is to take place and which can be connected to the metering unit according to the invention by means of the outlet (9), is thus transferred for the purpose of being filled by means of metering to the metering system (20) according to the invention in order to be filled there.

The metering system (20) according to the invention is preferably a volumetric or gravimetric metering system, particularly preferably a gravimetric metering system.

The metering system (20) according to the invention preferably comprises at least one height adapter (25), by means of which the container (1) according to the invention can be positioned at any desired height within the metering system (20).

In addition to the at least one container (1) used as at least one, preferably mobile, metering station, the metering system (20) according to the invention preferably furthermore contains at least one supply container (21), which is connected by means of at least one pipe (22) to at least one metering valve (23), which is a permanent component part of the metering system. The at least one pipe (22) is preferably also a permanent component part of the metering system. Such a metering system (20) according to the invention represents a combination of a conventional metering system, which preferably comprises at least pivotable and fixed metering valves and pipes connected thereto, which are connected in turn to supply containers containing the components to be metered, and at least one container (1) according to the invention used as a metering station.

Methods According to the Invention

A further subject of the present invention is a method for pneumatic metering using the container (1) according to the invention, wherein the method comprises at least one step (i), namely
(i) pneumatic metering of a component situated in the container (1) according to the invention into another container (10) different from the container (1).

A further subject of the present invention is a method for producing a coating composition or a precursor thereof that can be used in the automotive industry, wherein the method comprises at least one step (a), namely
(a) pneumatic metering of a component situated in the container (1) according to the invention into another container different from the container (1), wherein, after being produced, the coating composition or the precursor thereof is present in this container (10) different from the container (1).

All the preferred embodiments described hereinabove in connection with the container (1) according to the invention and the use according to the invention and the metering system according to the invention are also preferred embodiments in respect of the methods according to the invention.

The methods according to the invention are preferably carried out within and by means of the metering system (20) according to the invention.

The method according to the invention is a method for producing a coating composition or a precursor thereof that can be used in the automotive industry. In this context, it is possible to produce both coating compositions which are used in the context of OEM series-production coating and those which can be used in the context of repair coating. The same applies to corresponding precursors. The method according to the invention is preferably used in the development of coating compositions or precursors thereof that can be used in the automotive industry, preferably within laboratories, such as research and development laboratories.

Coating compositions that can be used in the automotive industry are, for example, electrodeposition coatings, primers, primer surfacers, base coats, especially water-based base coats, top coats, including clear coats, especially solvent-based clear coats. A precursor of a coating composition that can be used in the automotive industry is preferably a pigment and/or filler paste. In this context, the term pigment paste includes colored pigment pastes and special-effect pigment pastes. Precursors furthermore comprise (temporary) intermediates which can be used to produce such coating compositions.

### EXAMPLES

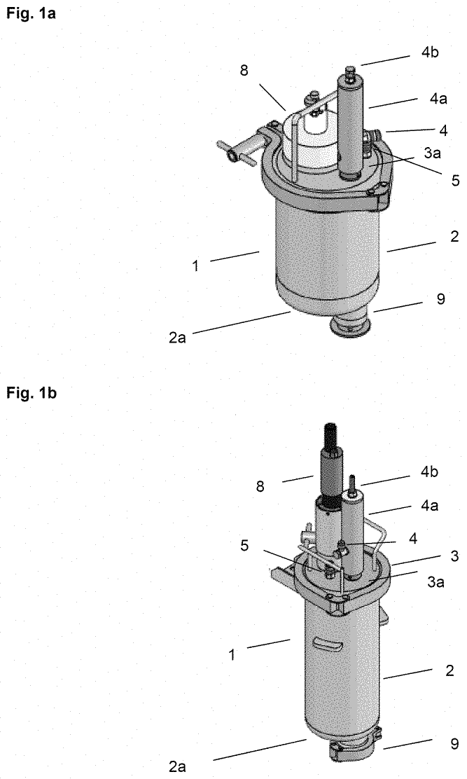

The following examples will serve to explain the invention but should not be interpreted as restrictive. The examples are described with reference to FIGS. 1a, 1b and 2 to 4, which describe illustrative embodiments according to the invention.

FIG. 1a and FIG. 1b are schematic illustrations of a container (1) according to the invention, which differ essentially only in shape and, as a result, in the volume of the container body (2) and hence of the container (1) and in the type of motor (8) used. In each case, the container (1) is in the closed state, and therefore none of the elements situated on the inside (3b) of the cover (3) are visible.

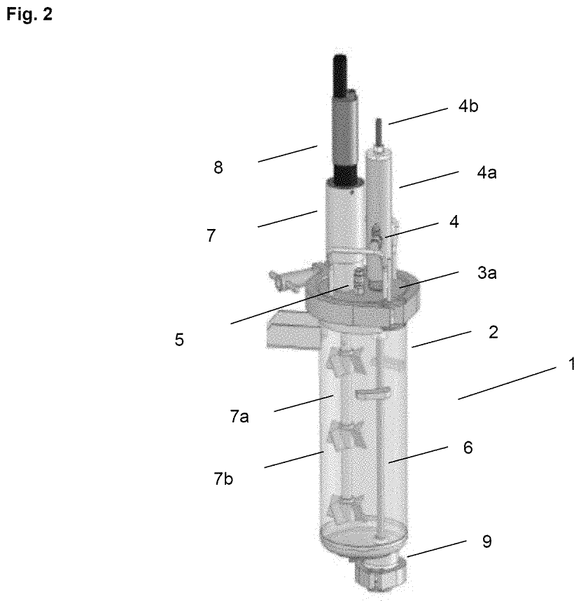

FIG. 2 is a schematic illustration of the closed container (1) according to the invention shown in FIG. 1b, but the elements situated within the container (1) have been made visible.

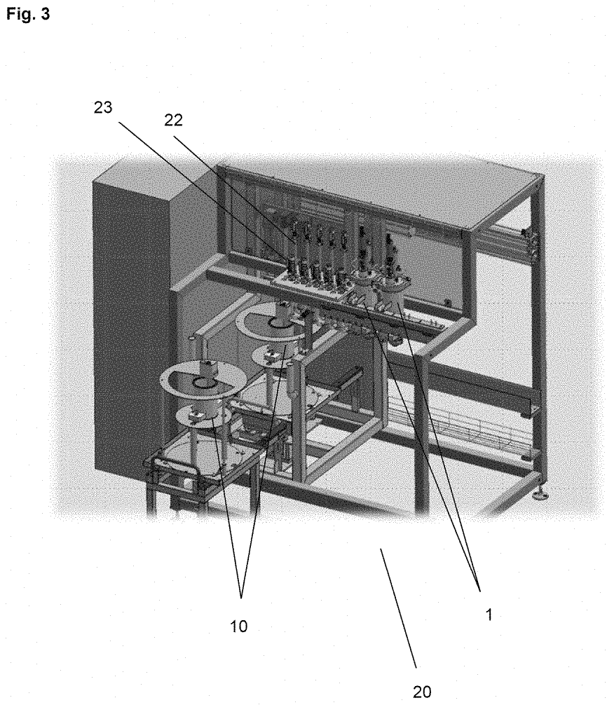

FIG. 3 is a schematic illustration of a metering system (20) according to the invention, which contains a combination of two closed containers (1) according to the invention and a total of five fixed pipes (22), wherein each of these fixed pipes (22) is connected to a respective metering valve (23), which is a permanent component part of the metering system. Moreover, two containers (10) to be filled, into which metering is to take place, are furthermore depicted in FIG. 3.

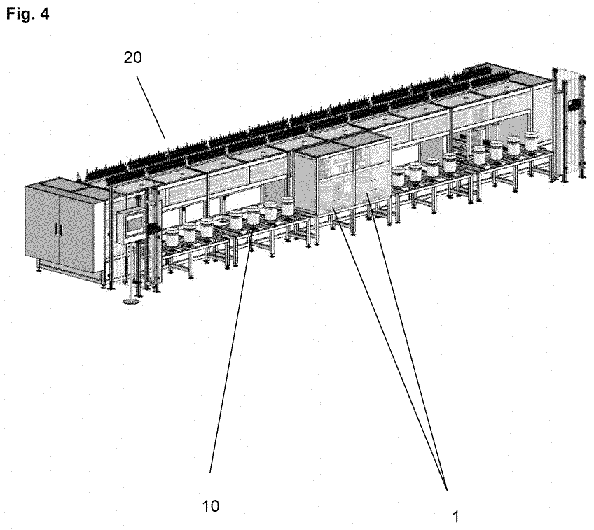

FIG. 4 is likewise a schematic illustration of a metering system according to the invention, which contains two closed containers (1) according to the invention. Moreover, a row of containers (10) to be filled, into which metering is to take place, are depicted in FIG. 4.

1. A container suitable for the pneumatic metering of a component situated therein into a second container different from the container, wherein the container comprises a container body, a container base, and a removable cover suitable for closing the container, wherein:
the container has at least one valve head that is recessed into the container base and to which it is possible to connect the second container and into which pneumatic metering of a component situated in the container can be performed,
at least one compressed air connection for the pneumatic driving of the valve head and at least one further compressed air connection are integrated into the cover of the container, wherein delivery of a component situated in the container for the purpose of metering into the second container can be performed by means of compressed air applied to the at least one further compressed air connection, and
a stirrer, which comprises a motor for driving the stirrer on the outside of the cover and which, on the inside of the cover, has a stirrer shaft, which can be driven by means of the motor and which comprises one or more stirring members mounted on the stirrer shaft, is integrated into the cover, wherein the stirrer shaft is arranged in such a way on the inside of the cover that it projects into the container body in the state of the container in which the container is closed by means of the cover.

2. The container as claimed in claim 1, wherein the at least one compressed air connection is part of a valve drive unit, which is situated on the outside of the cover.

3. The container as claimed in claim 1, wherein the container body is substantially round.

4. The container as claimed in claim 1, wherein the container body contains at least one component that can be used to produce a coating composition or a precursor thereof that can be used in the automotive industry and that is to be subjected to pneumatic metering.

5. The container as claimed in claim 1, wherein the at least one valve head is connected by means of a valve drive rod to a valve drive unit, which comprises the at least one compressed air connection and is situated on the outside of the cover.

6. The container as claimed in claim 1, wherein the at least one valve head contains at least two different valve openings and, as a result, is capable of metering both fine flows and coarse flows.

7. A method of using the container as claimed claim 1, the method comprising using the container as a metering station for the pneumatic metering of a component situated therein into a second container different from the container.

8. The method as claimed in claim 7, further comprising using the container as a mobile metering station.

9. The method as claimed in claim 7, further comprising using the container for the production of special-effect pigment pastes.

10. A metering system comprising at least one container as claimed in claim 1 as a metering station.

11. The metering system as claimed in claim 10, wherein the metering station is a gravimetric metering system.

12. The metering system as claimed in claim 10, wherein the metering system comprises up to 50 of the containers and hence up to 50 metering stations.

13. The metering system as claimed in claim 10, wherein, in addition to the at least one container used as the metering station, said system further comprises at least one supply container, which is connected by means of at least one pipe to at least one metering valve, which is a permanent component part of the metering system.

14. A method for pneumatic metering using the container as claimed in claim 1, wherein the method comprises:
(i) pneumatic metering of a component situated in the container into a second container different from the container.

15. A method for producing a coating composition or a precursor thereof that can be used in the automotive industry, wherein the method comprises:
(a) pneumatic metering of a component situated in the container as claimed in claim 1 into a second container different from the container, wherein, after being produced, the coating composition or the precursor thereof is present in the second container.
